(19) United States
(12) Patent Application Publication
(10) Pub. No.: US 2024/0357189 A1
(43) Pub. Date: Oct. 24, 2024

(54) SYNCHRONIZING AUDIO AND VIDEO USING PAUSE GAP ANALYSIS

(71) Applicant: International Business Machines Corporation, Armonk, NY (US)

(72) Inventors: Indervir Singh Banipal, San Jose, CA (US); Hemant Kumar Sivaswamy, Pune (IN); Vijay Ekambaram, Chennai (IN)

(21) Appl. No.: 18/303,021

(22) Filed: Apr. 19, 2023

(51) Int. Cl. H04N 21/242; H04N 21/233; H04N 21/25

(52) U.S. Cl. CPC H04N 21/242; H04N 21/233; H04N 21/251

(57) ABSTRACT

A computer-implemented method, a computer program product, and a computer system for synchronizing audio and video using pause gap analysis. A computer splits a video into an audio stream and a video stream. A computer identifies time points at which there is no sound in the audio stream and derives pause gaps in the audio stream. A computer applies a binary classifier to predict sound presence or absence in frames of the video stream and derives pause gaps in the video stream. A computer identifies desynchronization between the pause gaps in the video stream and the pause gaps in the audio stream. A computer aligns the pause gaps in the video stream with the pause gaps in the audio stream, based on metadata of the pause gaps in the video stream.

### BACKGROUND

The present invention relates generally to synchronization of audio and video, and more particularly to synchronizing audio and video using pause gap analysis.

When a news video or streaming content is streamed live and there are network bandwidth related issues, a audio stream are not synchronized with a video stream. Several techniques for solving the problem of desynchronization exists in literature. However, the existing techniques need sophisticated object detection analysis (for example, lip sync, etc.) which is heavy for runtime, online processing, and rendering.

### SUMMARY

In one aspect, a computer-implemented method for synchronizing audio and video using pause gap analysis is provided. The computer-implemented method includes splitting a video into an audio stream and a video stream. The computer-implemented method further includes identifying time points at which there is no sound in the audio stream and deriving pause gaps in the audio stream. The computer-implemented method further includes applying a binary classifier to predict sound presence or absence in frames of the video stream and deriving pause gaps in the video stream. The computer-implemented method further includes identifying desynchronization between the pause gaps in the video stream and the pause gaps in the audio stream. The computer-implemented method further includes aligning the pause gaps in the video stream with the pause gaps in the audio stream, based on metadata of the pause gaps in the video stream.

In another aspect, a computer program product for synchronizing audio and video using pause gap analysis is provided. The computer program product comprises a computer readable storage medium having program instructions embodied therewith, and the program instructions are executable by one or more processors. The program instructions are executable to: split a video into an audio stream and a video stream; identify time points at which there is no sound in the audio stream and deriving pause gaps in the audio stream; apply a binary classifier to predict sound presence or absence in frames of the video stream and derive pause gaps in the video stream; identify desynchronization between the pause gaps in the video stream and the pause gaps in the audio stream; and align the pause gaps in the video stream with the pause gaps in the audio stream, based on metadata of the pause gaps in the video stream.

In yet another aspect, a computer system for synchronizing audio and video using pause gap analysis is provided. The computer system comprises one or more processors, one or more computer readable tangible storage devices, and program instructions stored on at least one of the one or more computer readable tangible storage devices for execution by at least one of the one or more processors. The program instructions are executable to split a video into an audio stream and a video stream. The program instructions are further executable to identify time points at which there is no sound in the audio stream and deriving pause gaps in the audio stream. The program instructions are further executable to apply a binary classifier to predict sound presence or absence in frames of the video stream and derive pause gaps in the video stream. The program instructions are further executable to identify desynchronization between the pause gaps in the video stream and the pause gaps in the audio stream. The program instructions are executable to align the pause gaps in the video stream with the pause gaps in the audio stream, based on metadata of the pause gaps in the video stream.

### BRIEF DESCRIPTION OF THE SEVERAL VIEWS OF THE DRAWINGS

FIG. 1 illustrates identifying pause gaps in an audio stream in a training phase, in accordance with one embodiment of the present invention.

FIG. 2 illustrates learning a binary classifier in a training phase, in accordance with one embodiment of the present invention.

FIG. 3 illustrates identifying pause gaps in a video stream and synchronizing an audio stream and a video stream, in accordance with one embodiment of the present invention.

FIG. 4 illustrates using a trained binary classifier to identify pause gaps in a video stream, in accordance with one embodiment of the present invention.

FIG. 5 is a flowchart showing operational steps of learning a binary classifier in a training phase, in accordance with one embodiment of the present invention.

FIG. 6 is a flowchart showing operational steps of using a trained binary classifier to identify pause gaps in a video stream and synchronizing an audio stream and a video stream, in accordance with one embodiment of the present invention.

FIG. 7 is a systematic diagram illustrating an example of an environment for the execution of at least some of the computer code for synchronizing audio and video using pause gap analysis, in accordance with one embodiment of the present invention.

### DETAILED DESCRIPTION

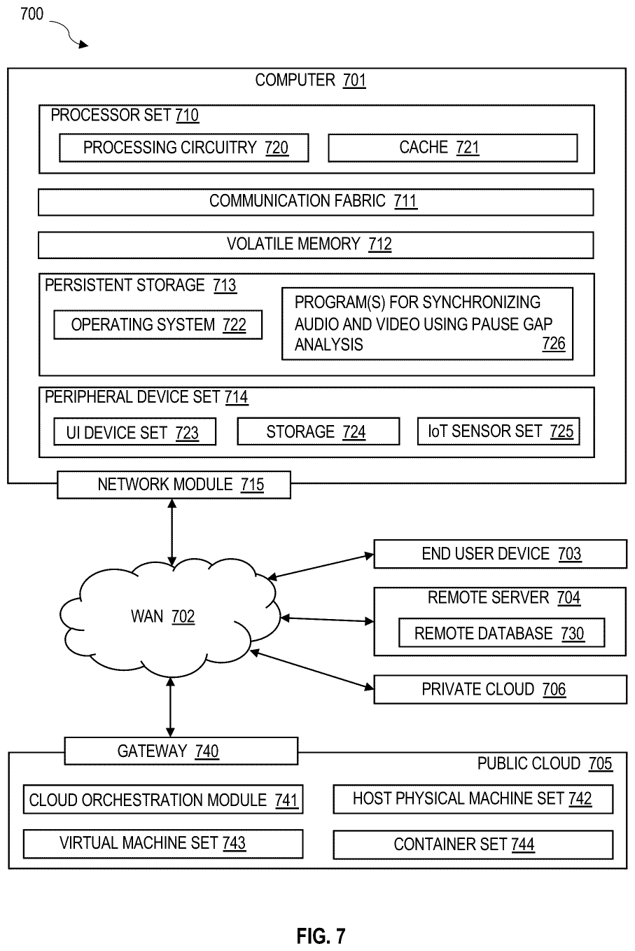

Embodiments of the present invention disclose a method and system for tackling the problem of desynchronization of audio and video. With the method and system, tackling the problem is done by discovering pause moments in the audio and video frames via learning a supervised binary classifier and aligning the pause moments based on metadata properties. The method and system quickly auto-sync misaligned audio and video streams, thereby providing a much feasible and practical AI (artificial intelligence) solution. The proposed method and system are implemented on computer or server, such as computer 701 in FIG. 7.

The disclosed method and system can be extended to other use cases. The disclosed method and system can be used to align audio-audio signals or audio-video signals using pause gap analysis. The disclosed method and system can be used to align different audio tracks sharing same beat patterns. In music production tools, the disclosed method and system can be used to align voice track with its associated background tracks. The disclosed method and system can be applied to any music production or audio processing system for syncing different tracks.

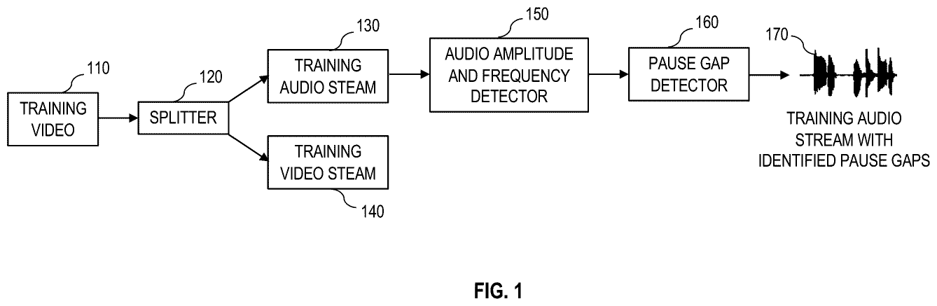

FIG. 1 illustrates identifying pause gaps in an audio stream in a training phase, in accordance with one embodiment of the present invention. In the proposed method and system, training video 110 from a training set is fed to splitter 120, and then training video 110 is split into training audio steam 130 and training video stream 140. Videos in the training set are normal videos which have no problem of desynchronization of audio and video. Training audio steam 130 is fed into audio amplitude and frequency detector 150. The output of audio amplitude and frequency detector 150 is fed into pause gap detector 160. Pause gap detector 160 discovers pause moments in training audio steam 130 and thus the proposed method and system obtain training audio stream 170 with identified pause gaps. In the identified pause gaps, there is no sound. The proposed method and system convert audio stream 170 with identified pause gaps into a binary stream. For example, if “1” represents sound presence and “0” represents sound absence in the audio stream, audio stream 170 with identified pause gaps will be converted into a binary stream like “0101001001010”.

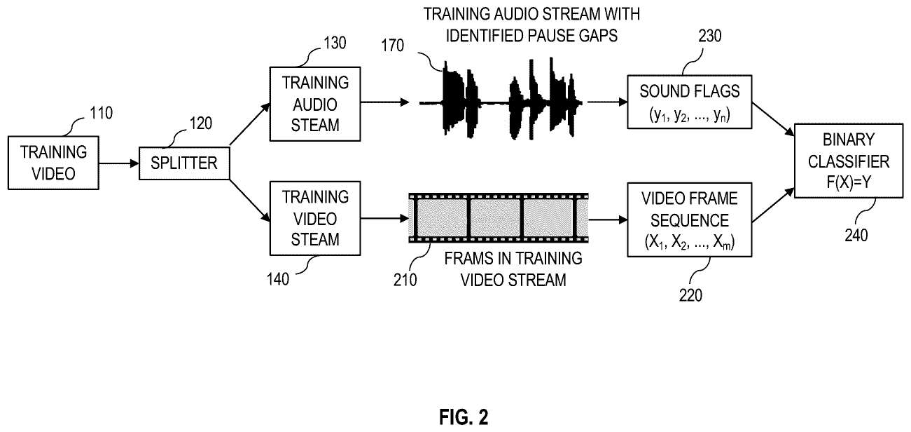

FIG. 2 illustrates learning a binary classifier in a training phase, in accordance with one embodiment of the present invention. As described previously with reference FIG. 1, training video 110 is split into training audio steam 130 and training video stream 140 by splitter 120. From training audio steam 130, the proposed method and system obtain training audio stream 170 with identified pause gaps. The proposed method and system further obtain sound flags 230 in training audio stream 170 with identified pause gaps, where the sound flags can be denoted as y₁, y₂, . . . , yₙ. Binary values of y₁, y₂, . . . , yₙ identify time points at which there is sound or no sound in training audio steam 130.

Training video stream 140 includes frames 210. The proposed method and system identify video frame sequences 220 which can be denoted as X₁, X₂, . . . , Xₘ. Using sound flags 230 and video frame sequences 220, the proposed method and system train binary classifier 240 through supervised machine learning. The binary classifier is a function of F(X)=Y; for a given video frame Xᵢ, the binary classifier outputs a binary value of Yᵢ. The binary value of Yᵢ indicates whether there is sound in the video frame Xᵢ.

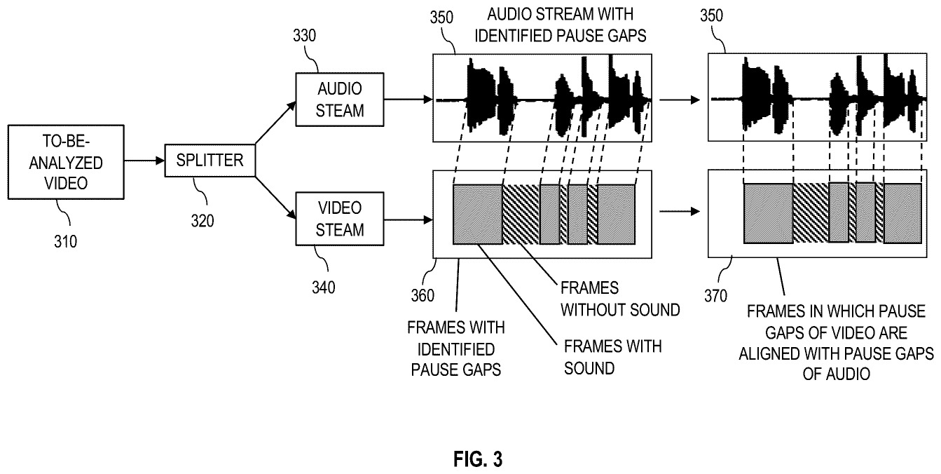

FIG. 3 illustrates identifying pause gaps in a video stream and synchronizing an audio stream and a video stream, in accordance with one embodiment of the present invention. To-be-analyzed video 310 is fed into splitter 320. To-be-analyzed video 310 has a problem of desynchronization of audio and video. Splitter 320 splits to-be-analyzed video 310 into audio stream 330 and video stream 340. From audio stream 330, the proposed method and system identify pause gaps in the audio stream, obtaining audio stream 350 with identified the pause gaps. Within the pause gaps of the audio stream, there is no sound. From video stream 340, the proposed method and system identify frames 360 with identified pause gaps in the video stream. To identify the pause gaps in the video stream, the proposed method and system use binary classifier 240.

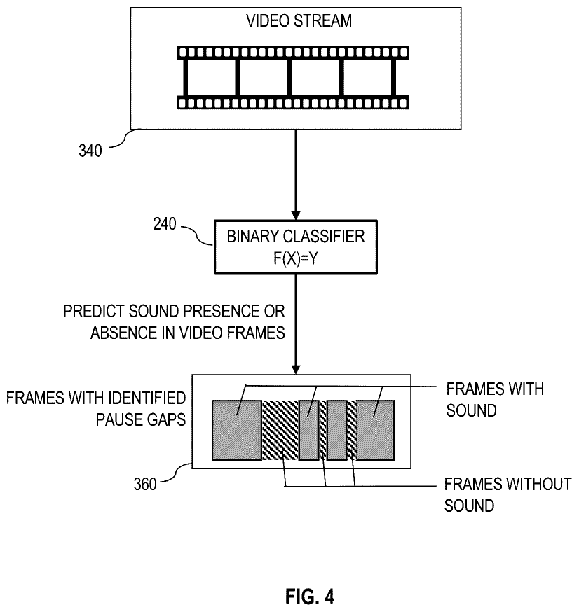

Now, referring to FIG. 4, FIG. 4 illustrates using a trained binary classifier to identify pause gaps in a video stream, in accordance with one embodiment of the present invention. As shown in FIG. 4, video stream 340 is fed into binary classifier 240. Binary classifier 240 predicts sound presence or absence in frames of video stream 340. The proposed method and system use binary classifier 240 to obtains frames 360 with identified pause gaps. As shown in FIG. 4, in frames 360, frames with sound and frames without sound are identified, based on the prediction by binary classifier 240. The frames without sound are the pause gaps in video stream 340.

Referring back to FIG. 3, FIG. 3 illustrates that the pause gaps in audio steam 350 are misaligned with the pause gaps in frames 360 of the video stream. For each pause gap in the video stream, the proposed method and system obtains its associated metadata such as a sequence number and a pause length, etc. Based on the metadata, the proposed method and system align the pause gaps in frames 360 of the video stream with the pause gaps in audio steam 350. The proposed method and system produce frames 370 in which the pause gaps of video are aligned with the pause gaps of audio. As a result, the problem of desynchronization of audio and video in the to-be-analyzed video 310 is remedied, and audio stream 330 and video stream 340 are synchronized.

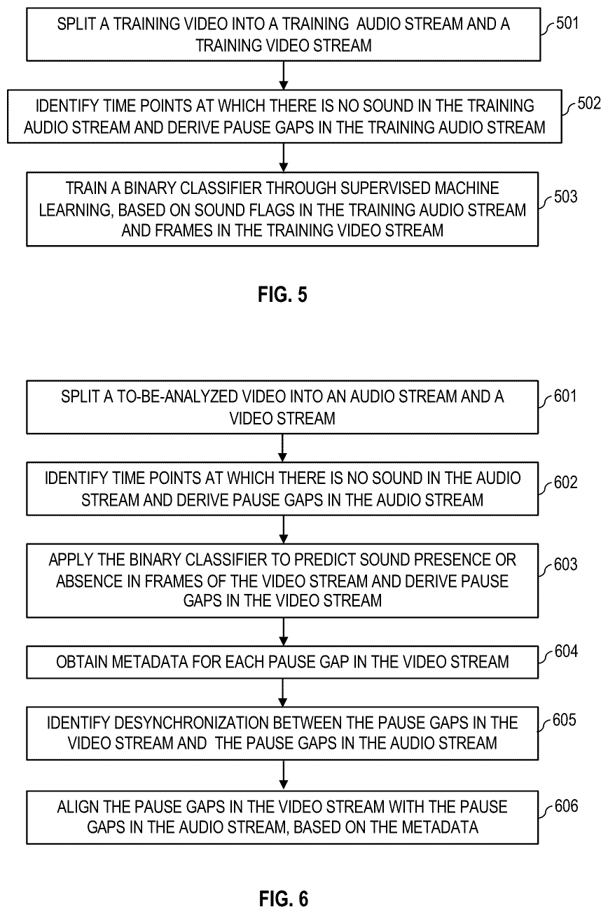

FIG. 5 is a flowchart showing operational steps of learning a binary classifier in a training phase, in accordance with one embodiment of the present invention. The operational steps are implemented by a computer or server (such as computer 701 in FIG. 7). The binary classifier is trained by the computer or server through supervised machine learning.

In step 501, the computer or server splits a training video into a training audio stream and a training video stream. The training video is from a training set, and videos in the training set are normal videos which have no problem of desynchronization of audio and video. Any normal video can be used as a training video, which makes training easy and scalable. In the example shown in FIG. 1 or FIG. 2, splitter 120 hosted by the computer or server splits training video 110 into training audio stream 130 and training video stream 140.

In step 502, the computer or server identifies time points at which there is no sound in the training audio stream and derives pause gaps in the training audio stream. The computer or server converts the training audio stream to a binary steam with sound flags. The sound flags identify the time points at which there is sound or no sound in the training audio stream. For example, the training audio stream with identified pause gaps will be converted into a binary stream like “0101001001010”. In the example shown in FIG. 1, training audio steam 130 is fed into audio amplitude and frequency detector 150 and then fed into pause gap detector 160. Audio amplitude and frequency detector 150 and pause gap detector 160 are hosted by the computer or server. Pause gap detector 160 discovers pause moments in training audio steam 130.

In step 503, the computer or server trains a binary classifier through supervised machine learning, based on sound flags in the training audio stream and frames in the training video stream. Through supervised machine learning, the computer or server uses the sound flags and frames in the training video stream to learn the binary classifier F(X)=Y. In an inference phase, given a video frame Xᵢ, the binary classifier F(X)=Y will predict a binary value of Yᵢ; the binary value of Yᵢ indicates whether there is sound or not in the video frame Xᵢ.

FIG. 6 is a flowchart showing operational steps of using a trained binary classifier to identify pause gaps in a video stream and synchronizing an audio stream and a video stream, in accordance with one embodiment of the present invention. The operational steps are implemented by a computer or server (such as computer 701 in FIG. 7). The operational steps are for synchronizing an audio stream and a video stream in a video.

In step 601, the computer or server splits a to-be-analyzed video into an audio stream and a video stream. In the example shown in FIG. 3, splitter 320 hosted in the computer or server splits to-be-analyzed video 310 into audio stream 330 and video stream 340.

In step 602, the computer or server identifies time points at which there is no sound in the audio stream and derives pause gaps in the audio stream. The computer or server converts the audio stream (which is extracted from the to-be-analyzed video) into a binary stream. The binary stream indicates at what time points sound is present and at what time points sound is absence in the audio stream. Thus, by identifying the time points at what time points there is no sound, the computer or server determines the pause gaps in the audio stream in the audio stream. For example, the identified pause gaps in the audio stream can be represented by 0 in the binary stream.

In step 603, the computer or server applies the binary classifier to predict sound presence or absence in frames of the video stream and derive pause gaps in the video stream. As described in previous paragraphs, the binary classifier F(X)=Y has been learned through supervised machine learning. By feeding the video stream (which is extracted from the to-be-analyzed video) into the binary classifier F(X)=Y, the computer or server obtains binary values of Y for corresponding frames X in the video stream. The binary values of Y indicate whether the sound presence or absence in corresponding frames X in the video stream. Based on the binary values of Y, the computer or server determines whether the sound presence or absence in video frames, and the computer or server further determines the pause gaps within which there is no sound.

In step 604, the computer or server obtains metadata for each pause gap in the video stream. For a pause gap in the video stream, its associated metadata includes video frame sequence numbers and the length of the pause gap, etc.

In step 605, the computer or server identifies desynchronization between the pause gaps in the video stream and the pause gaps in the audio stream. In the example shown in FIG. 3, the computer or server identifies existence of desynchronization between the pause gaps in audio steam 350 and the pause gaps in frames 360 of the video stream.

In response to identifying the existence of the desynchronization between the pause gaps in the video stream and the pause gaps in the audio stream, in step 606, the computer or server aligns the pause gaps in the video stream with the pause gaps in the audio stream, based on the metadata obtained in step 604. As a result, the computer or server remedies the desynchronization between the pause gaps in the video stream and the pause gaps in the audio stream, and the computer or server produces a video with synchronization between the audio stream and the video stream. In the example shown in FIG. 3, the computer or server aligns the pause gaps in frames 360 of the video stream with the pause gaps in audio steam 350; as a result, the computer or server generates frames 370 with synchronization between audio stream 330 and video stream 340.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In FIG. 7, computing environment 700 contains an example of an environment for the execution of at least some of the computer code involved in performing the inventive methods, such as program(s) 726 for synchronizing audio and video using pause gap analysis. In addition to block 726, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 726, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

Computer 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

Processor set 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 726 in persistent storage 713.

Communication fabric 711 is the signal conduction paths that allow the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 712 is any type of volatile memory now known or to be developed in the future. Examples include dynamic type random access memory (RAM) or static type RAM. Typically, the volatile memory is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

Persistent storage 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface type operating systems that employ a kernel. The code included in block 726 typically includes at least some of the computer code involved in performing the inventive methods.

Peripheral device set 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

Network module 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

Remote server 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

Public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

What is claimed is:

1. A computer-implemented method for synchronizing audio and video using pause gap analysis, the method comprising:
splitting a video into an audio stream and a video stream;
identifying time points at which there is no sound in the audio stream and deriving pause gaps in the audio stream;
applying a binary classifier to predict sound presence or absence in frames of the video stream and deriving pause gaps in the video stream;
identifying desynchronization between the pause gaps in the video stream and the pause gaps in the audio stream; and
aligning the pause gaps in the video stream with the pause gaps in the audio stream, based on metadata of the pause gaps in the video stream.

2. The computer-implemented method of claim 1, further comprising:
splitting a training video into a training audio stream and a training video stream;
identifying time points at which there is no sound in the training audio stream and deriving pause gaps in the training audio stream;
converting the training audio stream into a binary stream with sound flags identifying the time points; and
using the sound flags and frames in the training video stream to train the binary classifier.

3. The computer-implemented method of claim 2, wherein the training video is a normal video which has no desynchronization of the training audio stream and the training video stream.

4. The computer-implemented method of claim 2, wherein training the binary classifier is through supervised machine learning.

5. The computer-implemented method of claim 1, further comprising:
feeding the video stream into the binary classifier to obtain binary values which indicate whether the sound presence or absence in the frames of the video stream.

6. The computer-implemented method of claim 1, wherein, by aligning the pause gaps in the video stream with the pause gaps in the audio stream, the video stream and the audio stream are synchronized.

7. A computer program product for synchronizing audio and video using pause gap analysis, the computer program product comprising a computer readable storage medium having program instructions stored therewith, the program instructions executable by one or more processors, the program instructions executable to:
split a video into an audio stream and a video stream;
identify time points at which there is no sound in the audio stream and deriving pause gaps in the audio stream;
apply a binary classifier to predict sound presence or absence in frames of the video stream and derive pause gaps in the video stream;
identify desynchronization between the pause gaps in the video stream and the pause gaps in the audio stream; and
align the pause gaps in the video stream with the pause gaps in the audio stream, based on metadata of the pause gaps in the video stream.

8. The computer program product of claim 7, further comprising the program instructions stored on the computer readable storage medium, the program instructions executable to:
split a training video into a training audio stream and a training video stream;
identify time points at which there is no sound in the training audio stream and deriving pause gaps in the training audio stream;
convert the training audio stream into a binary stream with sound flags identifying the time points; and
use the sound flags and frames in the training video stream to train the binary classifier.

9. The computer program product of claim 8, wherein the training video is a normal video which has no desynchronization of the training audio stream and the training video stream.

10. The computer program product of claim 8, wherein training the binary classifier is through supervised machine learning.

11. The computer program product of claim 7, further comprising the program instructions stored on the computer readable storage medium, the program instructions executable to:
feed the video stream into the binary classifier to obtain binary values which indicate whether the sound presence or absence in the frames of the video stream.

12. The computer program product of claim 7, wherein, by aligning the pause gaps in the video stream with the pause gaps in the audio stream, the video stream and the audio stream are synchronized.

13. A computer system for synchronizing audio and video using pause gap analysis, the computer system comprising one or more processors, one or more computer readable tangible storage devices, and program instructions stored on at least one of the one or more computer readable tangible storage devices for execution by at least one of the one or more processors, the program instructions executable to:
split a video into an audio stream and a video stream;
identify time points at which there is no sound in the audio stream and deriving pause gaps in the audio stream;
apply a binary classifier to predict sound presence or absence in frames of the video stream and derive pause gaps in the video stream;
identify desynchronization between the pause gaps in the video stream and the pause gaps in the audio stream; and
align the pause gaps in the video stream with the pause gaps in the audio stream, based on metadata of the pause gaps in the video stream.

14. The computer system of claim 13, further comprising the program instructions stored on the at least one of the one or more computer readable tangible storage devices, the program instruction executable to:
split a training video into a training audio stream and a training video stream;
identify time points at which there is no sound in the training audio stream and deriving pause gaps in the training audio stream;
convert the training audio stream into a binary stream with sound flags identifying the time points; and
use the sound flags and frames in the training video stream to train the binary classifier.

15. The computer system of claim 14, wherein the training video is a normal video which has no desynchronization of the training audio stream and the training video stream.

16. The computer system of claim 14, wherein training the binary classifier is through supervised machine learning.

17. The computer system of claim 13, further comprising the program instructions stored on the at least one of the one or more computer readable tangible storage devices, the program instruction executable to:
feed the video stream into the binary classifier to obtain binary values which indicate whether the sound presence or absence in the frames of the video stream.

18. The computer system of claim 15, wherein, by aligning the pause gaps in the video stream with the pause gaps in the audio stream, the video stream and the audio stream are synchronized.
